(19) United States
(12) Patent Application Publication
(10) Pub. No.: US 2026/0204893 A1
(43) Pub. Date: Jul. 16, 2026

(54) ELECTRO-MECHANICAL CIRCUIT INTERRUPTER

(71) Applicant: LEACH INTERNATIONAL CORPORATION, Buena Park, CA (US)

(72) Inventors: ANHTAI TRAN, Garden Gove, CA (US); CHAD UYEHARA, Honolulu, HI (US)

(21) Appl. No.: 19/208,353

(22) Filed: May 14, 2025

Related U.S. Application Data
(60) Provisional application No. 63/744,733, filed on Jan. 13, 2025.

(51) Int. Cl. H02H 3/087; H01H 33/16; H02H 3/06

(52) U.S. Cl. CPC H02H 3/087; H01H 33/165; H02H 3/066

(57) ABSTRACT

An electro-mechanical circuit interrupter including an electro-mechanical switchgear including contacts coupled between a first terminal of the electro-mechanical circuit interrupter and a second terminal of the electro-mechanical circuit interrupter and configured to selectively open or close in response to a control signal, and a fuse electrically coupled between the first terminal and a first moveable contact of the contacts.

### CROSS-REFERENCE TO RELATED APPLICATION(S

This application claims priority to, and the benefit of, U.S. Provisional Application No. 63/744,733 (“SYSTEM AND METHOD FOR PROTECTING ELECTRO-MECHANICAL CIRCUIT INTERRUPTER”), filed on January 13, 2025, the entire content of which is incorporated herein by reference.

### FIELD

Aspects of embodiments of the present disclosure are generally related to electro-mechanical switchgears and circuit interrupters.

### BACKGROUND

In high voltage direct current (HVDC) applications, ensuring the safety and reliability of electrical systems is of utmost importance. Traditional solutions, such as pyrofuses and high voltage fuses, are employed to protect circuits from overcurrent conditions. Pyrofuses, which utilize pyrotechnic elements to achieve rapid disconnection, are non-resettable and can pose operational hazards due to their potential for self-activation at elevated temperatures, which can occur at high voltage and high current conditions. This characteristic makes them unsuitable for environments where reusability, ease of replacement, and safety are of significant concern, such as in aerospace applications. High voltage fuses, while effective in interrupting current flow by melting a fusible link, often struggle with slow response times during short circuits , or contrary, can inadvertently open during typical inrush currents or nominal overload conditions. These limitations highlight the need for a more reliable and efficient solution to manage high-current ruptures in high voltage systems.

Another common approach faces challenges in handling high rupture currents due to susceptibility to arc damage during high current interruptions. The formation of arcs between separating components can lead to significant deterioration and reduced lifespan. Additionally, the rapid change in current during interruptions can generate high voltage spikes, exacerbating the problem by prolonging arc duration and causing further damage. Existing techniques, such as magnetic blowout and arc suppression, attempt to mitigate these issues but often fall short in increasing the rupture current capability. This underscores the need for an innovative approach that can effectively address these challenges, ensuring both safety and efficiency in HVDC, high current applications.

The above information disclosed in this Background section is only for enhancement of understanding of the present disclosure, and therefore it may contain information that does not form the prior art that is already known to a person of ordinary skill in the art.

### SUMMARY

Aspects of embodiments of the present disclosure are directed to an electro-mechanical circuit interrupter (EMCI) for high-current rupture in high voltage direct current (HVDC) and high current applications. The system incorporates mechanisms to rapidly and safely interrupt high current flow, which reduce (e.g., minimize) the risk of electrical hazards. By integrating an electro-mechanical contactor for galvanic isolation and a fuse component for arc suppression, the system ensures rapid and reliable disconnection even under extreme current conditions in a high voltage system. This approach enhances the safety and efficiency of high voltage electrical systems, providing a robust solution for managing high-current ruptures, which also reduces space requirements and power dissipation. Relative to circuit interrupters of the related art, the electro-mechanical circuit interrupter of the present disclosure provides a more compact, lower cost, lower complexity solution that can operate at higher voltages and currents (e.g., at about 1,000 volts and 50,000 amps). This and other effects make the electro-mechanical circuit interrupter suitable for many applications such as electric vehicles (EVs), vertical takeoff and landing (VTOL) vehicles, aerospace vehicles or the like.

According to some embodiments of the present disclosure, there is provided an electro-mechanical circuit interrupter including: an electro-mechanical switchgear including contacts coupled between a first terminal of the electro-mechanical circuit interrupter and a second terminal of the electro-mechanical circuit interrupter and configured to selectively open or close in response to a control signal; and a fuse electrically coupled between the first terminal and a first moveable contact of the contacts.

In some embodiments, the first terminal is coupled to a power source, and the second terminal is coupled to a load circuit.

In some embodiments, the second terminal is coupled to a power source, and the first terminal is coupled to a load circuit.

In some embodiments, the contacts include: a first stationary contact coupled to the first terminal; a second stationary contact coupled to the second terminal; a first moveable contact and a second moveable contact; a moveable arm fixedly coupling the first and second moveable contacts and configured to move in response to the control signal.

In some embodiments, the first moveable contact and the second moveable contact are configured to contact the first stationary contact and the second stationary contact, respectively, in a closed state of the contacts.

In some embodiments, the fuse is configured to prevent electrical arcing across the first stationary contact and the first moveable contact when opening, and to reduce arcing across the second stationary contact and the second moveable contact when opening.

In some embodiments, a current rating of the electro-mechanical circuit interrupter across the first and second terminals is greater than that of the fuse.

In some embodiments, in a closed state, a resistance of the electro-mechanical switchgear across the first and second terminals is lower than that of the fuse.

In some embodiments, the electro-mechanical circuit interrupter has an interrupt rating of 20,000 A to 50,000 A, and a current rating of the fuse is 10 A to 30 A.

In some embodiments, the control signal corresponds to an overcurrent condition or a short circuit condition at a load circuit coupled to the second terminal.

According to some embodiments of the present disclosure, there is provided an electro-mechanical circuit interrupter including: an electro-mechanical switchgear including a first contactor and a second contactor that are coupled in series between a power source and a load circuit, the first contactor having a first terminal, a second terminal, and a moveable arm configured to selectively connect the first and second terminals in response to a control signal; and a fuse electrically coupled between the first and second terminals of the first contactor.

In some embodiments, the fuse is configured to reduce electrical arcing across the moveable arm and a contact of the second terminal of the first contactor when opening, and the second contactor prevents current flow through the fuse.

In some embodiments, each of the first and second contactors is a single-break contactor.

In some embodiments, the second contactor has a first terminal, a second terminal, and a moveable arm configured to selectively connect the first and second terminals in response to the control signal, the first terminal of the first contactor is coupled to the power source, the second terminal of the first contactor is coupled to the second terminal of the second contactor, and the first terminal of the second contactor is coupled to the load circuit.

In some embodiments, in a closed state, a resistance of the first contactor across the first and second terminals is lower than that of the fuse.

In some embodiments, the control signal corresponds to an overcurrent condition or a short circuit condition at the load circuit coupled to the second contactor.

In some embodiments, the electro-mechanical circuit interrupter has an interrupt rating of 20,000 A to 50,000 A, and a current rating of the fuse is 10 A to 30 A.

### BRIEF DESCRIPTION OF THE DRAWINGS

The accompanying drawings, together with the specification, illustrate example embodiments of the present disclosure, and, together with the description, serve to explain the principles of the present disclosure.

FIG. 1A is a schematic diagram illustrating the electro-mechanical circuit interrupter (EMCI) of a high voltage system in an open state, according to some embodiments of the present disclosure.

FIG. 1B is a schematic diagram illustrating the electro-mechanical circuit interrupter in a closed state, according to some embodiments of the present disclosure.

FIG. 2A is a schematic diagram illustrating the electro-mechanical circuit interrupter in an open state in response to a fault condition, according to some embodiments of the present disclosure.

FIG. 2B is a schematic diagram illustrating the electro-mechanical circuit interrupter in a blown state in response to a fault condition, according to some embodiments of the present disclosure.

FIG. 3 illustrates an electro-mechanical circuit interrupter, according to some other embodiments of the present disclosure.

FIG. 4 illustrates an electro-mechanical circuit interrupter that utilizes a double-pole contactor, according to some embodiments of the present disclosure.

### DETAILED DESCRIPTION

The detailed description set forth below is intended as a description of example embodiments of a system for current interruption, provided in accordance with the present disclosure, and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In high voltage direct current (HVDC) systems (e.g., those with voltages at 270 VDC or higher), maintaining safety and reliability is paramount. In HVDC systems, electrical faults or accidents can lead to dangerous short circuits with thousands of amps. In the related art, safety disconnection devices such as pyrofuses and high voltage fuses are used to protect both equipment and personnel from sudden overcurrent conditions.

Pyrofuses, which use pyrotechnic elements to physically break a busbar connection in response to an external control signal, are designed to provide quick galvanic isolation of the short circuit, thus preventing potential hazards such as electric shocks, fires and further damage. However, given the nature of pyrotechnic elements, if the busbar reaches a particular temperature (e.g., as a result of high currents), the pyrofuse may be self-activated or ignited even in the absence of a trigger signal, which may pose operational hazards. Additionally, pyrofuses are inherently not switchable, testable or resettable.

High voltage fuses are designed to protect electrical circuits from overcurrent by melting a fusible link, which interrupts the flow of current. However, these fuses are passive devices that are not capable of distinguishing between typical inrush currents that could occur in the case of capacitive loads and nominal overload conditions within the electrical system, and can cause inadvertent circuit disruptions. Further, if the fuses are sized to handle the normal operation in HVDC/high current applications, they may be too bulky, heavy and may be too slow to respond to a short circuit condition. Additionally, the relative high resistance of a high voltage fuse increases its power dissipation and heat generation, which reduces overall system efficiency.

The present disclosure addresses these challenges by providing an electro-mechanical circuit interrupter (EMCI) with high rupture current capability in HVDC applications, such as in EVs and aerospace vehicles. In some embodiments, the EMCI utilizes a combination of an electro-mechanical contactor and a fuse to provide rapid and reliable disconnection even under extreme current conditions in a HVDC system.

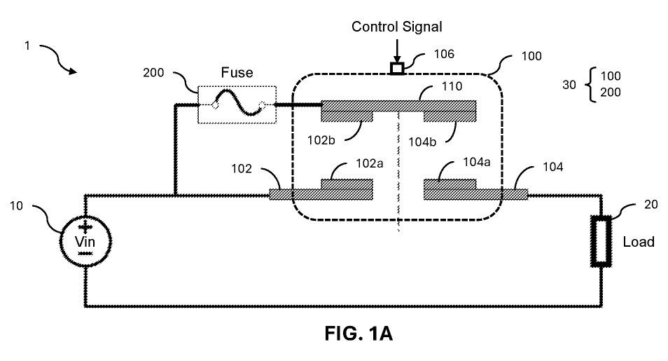

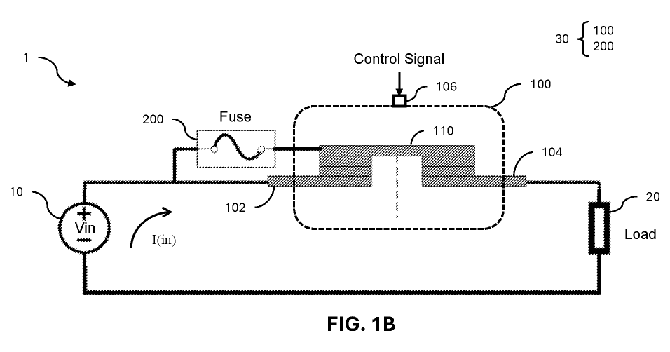

FIG. 1A is a schematic diagram illustrating the electro-mechanical circuit interrupter (EMCI) of a HVDC system in an open state, according to some embodiments of the present disclosure. FIG. 1B is a schematic diagram illustrating the electro-mechanical circuit interrupter in a closed state, according to some embodiments of the present disclosure.

Referring to FIGS. 1A-1B, the HVDC system 1 includes an input power source (e.g., a high voltage battery) 10, a system load or load circuit (e.g., an electric motor), and the electro-mechanical circuit interrupter 30 connected between and in series with the power source 10 and load circuit 20. The electro-mechanical circuit interrupter 30 may be a 3-terminal device with a first terminal (e.g., an input terminal) 102 connected to input power source 10, a second terminal (e.g., an output terminal) 104 connected to load circuit 20, and a third terminal (e.g., a control terminal) 106 for receiving an external control signal (e.g., a fault signal).

In some embodiments, the electro-mechanical circuit interrupter 30 includes an electro-mechanical switchgear 100, which may act as a double-break contactor, and a fuse 200 coupled to the electro-mechanical switchgear 100.

The contacts of the electro-mechanical switchgear 100 are configured to selectively close to allow electrical current to pass through, and open to prevent passage of current through the electro-mechanical switchgear 100, in response to the control signal. The electro-mechanical switchgear 100 may use an electromagnet to open/close the contacts of the electro-mechanical switchgear 100 based on the control signal. The electro-mechanical switchgear 100 includes a pair of conductors that make up the first and second terminals 102 and 104 and which are physically separated from one another. The conductors 102 and 104 are respectively terminated with first and second stationary contacts 102a and 104a. The electro-mechanical switchgear 100 further includes a moveable arm 110 with first and second moveable contacts 102b and 104b at its ends. The first and second stationary contacts 102a and 104a are coupled to (e.g., directly coupled to) the first and second terminals 102 and 104. When the contacts close in response to the control signal received at the third terminal 106, the moveable arm 110 moves towards the pair of conductors and the first and second moveable contacts 102b and 104b come into contact with the first and second stationary contacts 102a and 104a, respectively, and establishes a current path between the first and second terminals 102 and 104.

In some embodiments, the fuse 200 may have a first electrode connected to (e.g., directly connected to) the first terminal 102, and a second electrode connected to (e.g., directly connected to) the moveable arm 110. That is, the fuse 200 may be connected in parallel to a first side (e.g., input side) of the double break contacts of the switchgear 100.

The switchgear 100 may be commanded to be closed, via the control signal, or may operate as a normally closed device to allow for current flow as shown in FIG. 1B. When the switchgear 100 is opened, the second side (e.g., load-side) contacts 104a and 104b provide galvanic isolation and prevent any current flow from the power source 10 to the load circuit 20.

During normal operation, when voltage is applied by the power source 10 and the switchgear 100 is closed, current flows through the contacts 102a, 102b, 104a, and 104b. The contact resistance of the closed switchgear 100 may be significantly lower (e.g., 50 times lower) than the on-resistance of the fuse 200. Therefore, in this state, only a small portion (e.g., about 2%) of the current flowing through the first and second terminals 102 and 104 of the circuit interrupter 30 may flow through the fuse 200. This allows the use of a small, low-cost fuse 200 that has a current rating that is substantially lower than that of the switchgear 100 and the circuit interrupter 30. For example, the fuse 200 may be a high voltage fuse having a current rating of about 10 A to about 30 A (e.g., about 20 A), while the circuit interrupter 30 has an interrupt rating of 20,000 amps to 50,000 amps. The lower current rating also corresponds to faster response times by the fuse 200. Therefore, the low current rating of the fuse 200 may not only reduce the overall size and cost of the circuit interrupter 30 but also significantly improve (e.g., decrease) its response time to fault conditions.

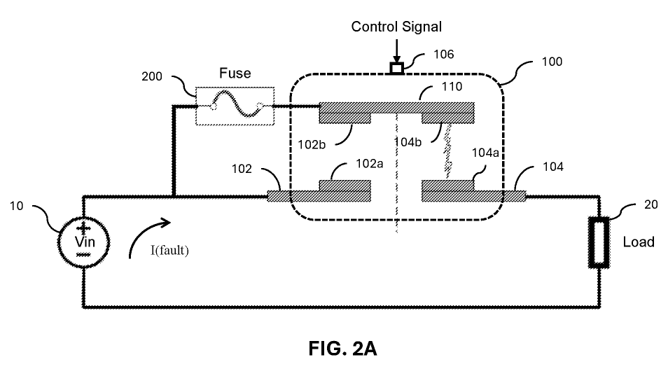

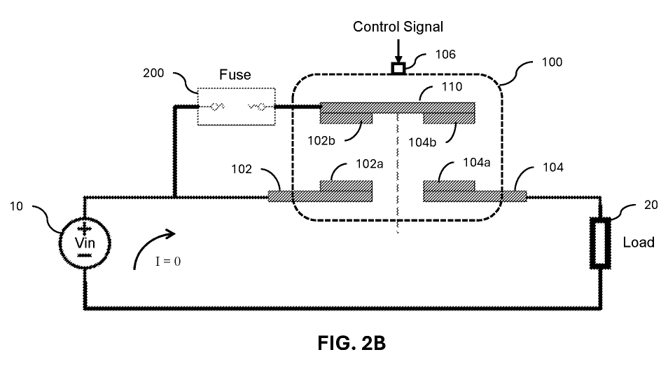

FIG. 2A is a schematic diagram illustrating the electro-mechanical circuit interrupter 30 in an open state in response to a fault condition, according to some embodiments of the present disclosure. FIG. 2B is a schematic diagram illustrating the electro-mechanical circuit interrupter 30 in a blown state in response to a fault condition, according to some embodiments of the present disclosure.

In some embodiments, when a short circuit or some fault condition occurs, a fault signal is sent to the third terminal 106 of the switchgear 100 to open and to isolate the fault by preventing further current flow from the power source 10.

In the absence of the fuse 200, the electro-mechanical switchgear may have a limited rupture capability (e.g., of less than 4,000 A) because it is highly susceptible to arc damage during a high current opening. An arc may be developed between the contacts when the contacts are separating. As a result, the contact material may either vaporized or transfer from one side to the other side, causing deterioration and fretting of the contacts. This phenomenon may substantially reduce the life and reliability of the switchgear. Further, when a high current is ruptured, especially in inductive circuits, the rapid change in current (di/dt) can cause significant issues. Upon interruption, the inductance in a circuit may resist the sudden change of current, generating a high voltage spike (V= L * di/dt). This voltage can far exceed the normal operating voltage of the system. This high voltage can prolong the duration of the arc that is formed between the contacts of the contactor. The arc, being a conductive plasma, allows current to continue flowing even after the contacts begin to separate. In some examples, once the inductive energy is dissipated, the arc is extinguished as the arc voltage required to sustain the plasma for a given gap between the contacts may be higher than the available power source voltage. In some other examples, the arc energy released during the high-current interruption event may generates intense heat. This heat may affect the arc voltage required to sustain the plasma to be lower than the power source voltage, resulting in continuous arcing. This persistent arcing can melt or erode the contact surfaces, causing significant damage to the contactors, even permanent failure.

According to some embodiments, with the fuse 200 present, as the switchgear 100 opens, the fault current may immediately flow through the fuse 200 without any arc on the first side contacts 102a and 102b, because the fuse presents a lower impedance path than the airgap formed between the first stationery and moveable contacts 102a and 102b. However, an arc may immediately be formed between the second stationery and moveable contacts 104a and 104b as they begin to separate, as shown in FIG. 2A.

In the moments after the opening of the switchgear 100, the fault current I(fault) underlying the arc, which may be very large (e.g., in the order of 1000 A to 4000 A), passes almost entirely through the fuse 200. Due to the low amperage rating of the fuse 200, it is able to respond very rapidly to the high fault current I(fault) (e.g., by breaking) and to become an open connection, which blocks the fault current and extinguishes the arc at the second side of the switchgear 100, as shown in FIG. 2B. For example, the fuse 200 may trip on the order of milliseconds (e.g., 1 ms to 10 ms) under all overload and short-circuit conditions. This protects the second side contacts 104a and 104b from fretting and prevents the deterioration of the contact material, thereby prolonging the usable lifespan of the switchgear 100 and reducing its replacement cost.

According to some embodiments, because the electro-mechanical circuit interrupter 30 employs electro-mechanical actuation to open and close, it is capable of providing traditional switchgear functionality when dry-switching (i.e., when not conducting any current). Further, as an overcurrent protection device, electro-mechanical actuation facilitates system maintenance, testing, and resetting. For example, a tripped (i.e., open) fuse 200 can be detected with an impedance test between the first stationary contact 102a and the mobile contact 110 when the switchgear 100 is opened to allow for system level interlock and prevent dormant failure. Additionally, in some embodiments, the fuse may be positioned remotely (i.e., far from the switchgear 100) for easy removal and replacement.

As shown in FIGS. 1A-2B, while the fuse 200 may be connected (e.g., directly connected) to the first side contacts 102a and 102b, embodiments of the present disclosure are not limited thereto. For example, the fuse 200 may instead be connected to the second side contacts 104a and 104b.

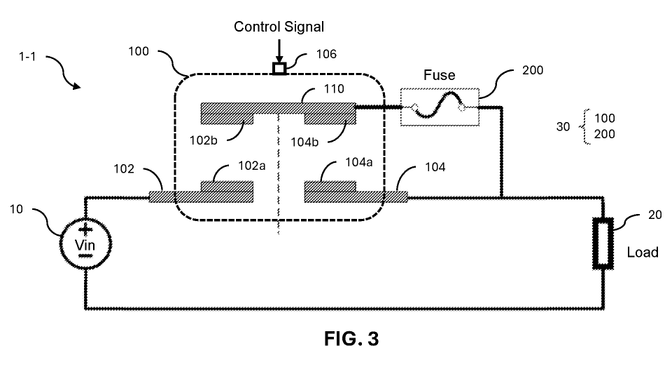

FIG. 3 illustrates an electro-mechanical circuit interrupter 30-1, according to some other embodiments of the present disclosure.

In some embodiments, the electro-mechanical circuit interrupter 30-1 is substantially the same as the electro-mechanical circuit interrupter 30 of FIGS. 1A-2B, except for the fuse 200 being connected in parallel to a second side (e.g., load side) of the double break contacts of the switchgear 100. That is, the fuse 200 may have a first electrode connected to (e.g., directly connected to) the second terminal 104, and a second electrode connected to (e.g., directly connected to) the moveable arm 110. As such, when the switchgear 100 is opened (e.g., in response to a fault condition), the first side contacts 102a and 102b provide galvanic isolation and prevent any current flow. Here, the fuse 200 extinguishes any arc that may be formed across the first side contacts 102a and 102b when opened. The operation of the electro-mechanical circuit interrupter 30-1 may be the same or substantially the same as that described above with respect to FIGS. 1A-2B, and thus a description thereof will not be repeated here.

While the embodiments of FIGS. 1A-3 utilize a switchgear that is in the form of a double-break contactor, embodiments of the present disclosure are not limited thereto.

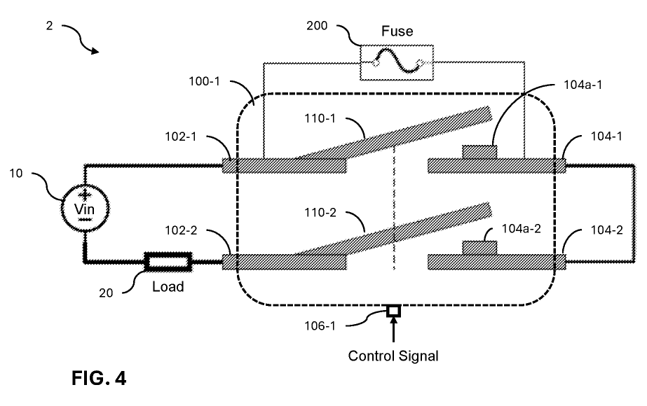

FIG. 4 illustrates an electro-mechanical circuit interrupter 30-2 that utilizes a double-pole contactor, according to some embodiments of the present disclosure.

Referring to FIG. 4, the electro-mechanical circuit interrupter 30-2 may include an electro-mechanical switchgear 100-1 and a fuse 200. In some embodiments, the switchgear 100-1 includes a double-pole contactor 100-1 having a first contactor (e.g., a first single-break contactor) and a second contactor (e.g., a second single-break contactor). The fuse 200 is coupled in parallel with one pole of the contactor 100-1, for example with the first contactor, as shown in FIG. 4. Each of the first and second contactors may have a first terminal 102-1/102-2 and a second terminal 104-1/104-2 and a moveable arm 110-1/110-2 that electrically couples the first and second terminals 102-1/102-2 and 104-1/104-2 in response to the same control signal received through the third terminal 106-1. The control signal may correspond to an overcurrent condition or a short circuit condition at the load circuit 20.

In some examples, the opposite electrodes of the fuse 200 may respectively be coupled (e.g., directly coupled) to the first and second terminals 102-1 and 104-1 to establish a parallel current path to the first contactor. As shown in FIG. 4, the first terminal 102-1 of the first contactor is coupled to the power source 10, the second terminal 104-1 of the first contactor is coupled to the second terminal 104-2 of the second contactor, and the first terminal 102-2 of the second contactor is coupled to the load circuit 20.

When the contactor 100-1 opens, an arc may begin to be formed between the contacts at the second terminal 104-1, which is immediately extinguished by the fuse 200 in a manner similar to that described previously above. As such, the fuse 200 is capable of protecting the contactor 100-1 against fretting and degradation. Here, galvanic isolation is achieved with the second pole to prevent current flows through the fuse 200 when the contactor 100-1 is opened, and the fuse 200 is still functional. For example, if the fuse 200 is still functional (i.e., effectively acting as an electrical short), then the second pole provides galvanic isolation. However, if the fuse is blown (i.e., acting as an electrical open), then both poles provide galvanic isolation. When the contractor 100-1 is in the open state and the fuse is functional, the second pole (between 102-2 and 104-2) provides the galvanic isolation to prevent current flow.

Similar to that described above with respect to FIG. 1A-3, in a closed state, a resistance of the first/second contactor across the first and second terminals 102-1/102-2 and 104-1/104-2 is lower than that of the fuse 200, and the electro-mechanical circuit interrupter 100-1 may have an interrupt rating of about 20,000 A to about 50,000 A, and the fuse 200 may have a current rating of about 10 A to 30 A.

In some examples, the electro-mechanical switchgear 100-1 may be a three-pole contactor (e.g., an AC contactor) having one or two poles left unused.

The terminology used herein is for the purpose of describing particular embodiments and is not intended to be limiting of the inventive concept. As used herein, the singular forms "a" and "an" are intended to include the plural forms as well, unless the context clearly indicates otherwise. It will be further understood that the terms "include", "including", "comprises", and/or "comprising", when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Expressions such as "at least one of", when preceding a list of elements, modify the entire list of elements and do not modify the individual elements of the list. Further, the use of "may" when describing embodiments of the inventive concept refers to "one or more embodiments of the inventive concept". Also, the term "exemplary" is intended to refer to an example or illustration.

It will be understood that, although the terms "first", "second", "third", etc., may be used herein to describe various elements, components, and/or sections, these elements, components, and/or sections should not be limited by these terms. These terms are used to distinguish one element, component, or section from another element, component, or section. Thus, a first element, component, or section discussed below could be termed a second element, component, or section, without departing from the scope of the inventive concept.

It will be understood that when an element is referred to as being "connected to" or "coupled to" another element, it can be directly connected to or coupled to the other element, or one or more intervening elements may be present. When an element is referred to as being "directly connected to" or "directly coupled to" another element, there are no intervening elements present.

As used herein, the terms "use", "using", and "used" may be considered synonymous with the terms "utilize", "utilizing", and "utilized", respectively.

While this disclosure has been described in detail with particular references to illustrative embodiments thereof, the embodiments described herein are not intended to be exhaustive or to limit the scope of the disclosure to the exact forms disclosed. Persons skilled in the art and technology to which this disclosure pertains will appreciate that alterations and changes in the described structures and methods of assembly and operation can be practiced without meaningfully departing from the principles, and scope of this disclosure, as set forth in the following claims and equivalents thereof.

What is claimed is:

1. An electro-mechanical circuit interrupter comprising:
an electro-mechanical switchgear comprising contacts coupled between a first terminal of the electro-mechanical circuit interrupter and a second terminal of the electro-mechanical circuit interrupter and configured to selectively open or close in response to a control signal; and
a fuse electrically coupled between the first terminal and a first moveable contact of the contacts.

2. The electro-mechanical circuit interrupter of claim 1, wherein the first terminal is coupled to a power source, and the second terminal is coupled to a load circuit.

3. The electro-mechanical circuit interrupter of claim 1, wherein the second terminal is coupled to a power source, and the first terminal is coupled to a load circuit.

4. The electro-mechanical circuit interrupter of claim 1, wherein the contacts comprise:
a first stationary contact coupled to the first terminal;
a second stationary contact coupled to the second terminal;
a first moveable contact and a second moveable contact;
a moveable arm fixedly coupling the first and second moveable contacts and configured to move in response to the control signal.

5. The electro-mechanical circuit interrupter of claim 4, wherein the first moveable contact and the second moveable contact are configured to contact the first stationary contact and the second stationary contact, respectively, in a closed state of the contacts.

6. The electro-mechanical circuit interrupter of claim 4, wherein the fuse is configured to prevent electrical arcing across the first stationary contact and the first moveable contact when opening, and to reduce arcing across the second stationary contact and the second moveable contact when opening.

7. The electro-mechanical circuit interrupter of claim 1, wherein a current rating of the electro-mechanical circuit interrupter across the first and second terminals is greater than that of the fuse.

8. The electro-mechanical circuit interrupter of claim 1, wherein, in a closed state, a resistance of the electro-mechanical switchgear across the first and second terminals is lower than that of the fuse.

9. The electro-mechanical circuit interrupter of claim 1, wherein the electro-mechanical circuit interrupter has an interrupt rating of 20,000 A to 50,000 A, and a current rating of the fuse is 10 A to 30 A.

10. The electro-mechanical circuit interrupter of claim 1, wherein the control signal corresponds to an overcurrent condition or a short circuit condition at a load circuit coupled to the second terminal.

11. An electro-mechanical circuit interrupter comprising:
an electro-mechanical switchgear comprising a first contactor and a second contactor that are coupled in series between a power source and a load circuit, the first contactor having a first terminal, a second terminal, and a moveable arm configured to selectively connect the first and second terminals in response to a control signal; and
a fuse electrically coupled between the first and second terminals of the first contactor.

12. The electro-mechanical circuit interrupter of claim 11, wherein the fuse is configured to reduce electrical arcing across the moveable arm and a contact of the second terminal of the first contactor when opening, and the second contactor prevents current flow through the fuse.

13. The electro-mechanical circuit interrupter of claim 11, wherein each of the first and second contactors is a single-break contactor.

14. The electro-mechanical circuit interrupter of claim 11, wherein the second contactor has a first terminal, a second terminal, and a moveable arm configured to selectively connect the first and second terminals in response to the control signal,
wherein the first terminal of the first contactor is coupled to the power source, the second terminal of the first contactor is coupled to the second terminal of the second contactor, and the first terminal of the second contactor is coupled to the load circuit.

15. The electro-mechanical circuit interrupter of claim 11, wherein, in a closed state, a resistance of the first contactor across the first and second terminals is lower than that of the fuse.

16. The electro-mechanical circuit interrupter of claim 11, wherein the control signal corresponds to an overcurrent condition or a short circuit condition at the load circuit coupled to the second contactor.

17. The electro-mechanical circuit interrupter of claim 11, wherein the electro-mechanical circuit interrupter has an interrupt rating of 20,000 A to 50,000 A, and a current rating of the fuse is 10 A to 30 A.
